(19) United States
(12) Patent Application Publication
(10) Pub. No.: US 2026/0056054 A1
(43) Pub. Date: Feb. 26, 2026

(54) SCIENTIFIC INSTRUMENT SUPPORT SYSTEMS AND METHODS FOR MITIGATING SPECTRAL DRIFT

(71) Applicant: Thermo Fisher Scientific (Bremen) GmbH, Bremen (DE)

(72) Inventors: Antonella Guzzonato, Bremen (DE); Shenghai Wu, Shanghai (CN); Werner Puschitz, Bremen (DE); Mischa Jahn, Bremen (DE); Kaice Reilly, Bremen (DE); Anastasia Kurnikova, Bremen (DE)

(21) Appl. No.: 19/106,991

(22) PCT Filed: Aug. 30, 2022
(86) PCT No.: PCT/CN2022/115787

§ 371 Date: Feb. 26, 2025

(51) Int. Cl. G01J 3/443; G01J 3/02; G01J 3/12; G01J 3/18; G01J 3/28

(52) U.S. Cl. CPC G01J 3/443; G01J 3/0208; G01J 3/0264; G01J 3/0286; G01J 3/1809; G01J 2003/1208; G01J 2003/2833; G01J 2003/2836; G01J 2003/2873

(57) ABSTRACT

Disclosed herein are scientific instrument support systems, related methods, computing devices and computer-readable media. A method of mitigating distortion of an optical emission spectrum obtained from an optical emission spectrometer is provided. The method may comprise a step of obtaining a spectrum recorded with the spectrometer and a respective one or more condition parameters indicative of an operating condition at a time of recording the spectrum. The method may further comprise a step of providing a model configured to output, in response to the one or more condition parameters, one or more transform parameters of a transformation to be applied to the obtained spectrum. A transformation may be applied in accordance with the obtained one or more transform parameters to the obtained spectrum to mitigate distortion of the spectrum due to a discrepancy between the operating condition and a baseline operating condition.

The present disclosure relates to mitigating distortion of an optical emission spectrum due to varying operating conditions of an optical spectrometer.

### BACKGROUND

Scientific instruments for obtaining optical spectra may include a complex arrangement of movable components, sensors, input and output ports, energy sources, and consumable components. As a result, obtained spectra are sensitive to changes in the operating conditions of the scientific instrument, for example changes in temperature. Known approaches for correcting optical spectra for changes in temperature are disclosed, for example, in WO2021/018992A1 and GB2586046, incorporated herein by reference. These approaches involve registering obtained spectra to a reference spectrum using identified peaks in the obtained spectra. Echelle dispersion gratings may be used in optical emission spectrometry in order to achieve high dispersion of light. When used in conjunction with a second dispersive element, such as a prism or another grating, a high-resolution 2D spectrum known as an echellogram, also referred to as full-frame or echelle spectrum, may be obtained.

A method may comprise obtaining a spectrum recorded with the spectrometer and a respective one or more condition parameters indicative of an operating condition of the optical emission spectrometer or an environment of the optical emission spectrometer at a time of recording the spectrum with the spectrometer and/or a preceding time. For example, in some embodiments, the one or more condition parameters may comprise a parameter indicative of a temperature. The one or more condition parameters indicative of a temperature may comprise, for example, at least one temperature measurement obtained from a temperature sensor attached to a mechanical structure of the optical emission spectrometer. In some embodiments, the one or more condition parameters may comprise a parameter correlated with or indicative of temperature. The one or more condition parameters may comprises one or more of: a parameter indicative of a heating current applied to a heating arrangement for heating and/or stabilizing the temperature of the optical system; a parameter indicative of a temperature of an environment of the spectrometer; a parameter indicative of a temperature of the optical system; a parameter indicative of at least one temperature measurement obtained from a temperature sensor attached to a mechanical structure supporting one or more optical components of the optical system; a parameter indicative of a radio frequency (RF) power of an RF generator for generating a plasma for use in obtaining the emission spectrum; a parameter indicative of a temperature of a power supply of the RF generator; a parameter indicative of a voltage of the power supply of the RF generator; a parameter indicative of a current of the power supply of the RF generator; a parameter indicative of a voltage applied to a heating pad attached to the optical system; a parameter indicative of the current at a control board of the scientific instrument; a parameter indicative of the current at a camera's printed circuit board (PCB); a parameter indicative of the current at an optic's PCB; a parameter indicative of a temperature of one or more components in a PCB; a parameter indicative of whether or not an additional gas option is installed; a parameter indicative of whether or not the plasma is turned on; a parameter indicative of an exhaust pressure of a plasma chamber for containing a plasma for use in obtaining the emission spectrum and a parameter indicative of a temperature of an exhaust tube. In some embodiments, the one or more condition parameters may comprise condition change parameters, indicative of a change of the condition or direction of change of the condition may be provided as part of input data for the model.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings,

FIG. 1 is a diagram of an example Inductive Coupled Plasma Optical Emission Spectrometer 1000 for obtaining optical emission spectra in accordance with some embodiments,

FIG. 2 is a block diagram of an example scientific instrument support module for performing support operations, in accordance with various embodiments.

FIG. 3 is an example full-frame spectrum of the intensity distribution captured by a photodetector.

FIG. 4 is an example of an estimated warp profile for registering a shifted spectrum to a reference spectrum in accordance with some embodiments.

FIG. 5 is a flow diagram of an example method of mitigating distortion of an optical emission spectrum in accordance with various embodiments.

FIG. 6 is a flow diagram of an example method of obtaining training data, in accordance with various embodiments.

FIG. 7 is a flow diagram of an example method of training a machine learning model in accordance with various embodiments.

FIG. 8 shows example input data for a machine learning model and example output data that the model is trained to provide in accordance with various embodiments.

FIG. 9A shows a prediction of lateral drift by a machine learning model in an example implementation. Left: actual drift (grey) and predicted drift (black) Right: prediction error (difference).

FIG. 9B shows a prediction of vertical drift by a machine learning model in the example implementation. Left: actual drift (grey) and predicted drift (black) Right: prediction error (difference). FIG. 9C shows a comparison between the actual lateral drift and the predicted lateral drift in exploratory testing of machine learning models trained using just one condition parameter.

FIG. 10 is an example of a graphical user interface that may be used in the performance of some or all of the support methods disclosed herein in accordance with various embodiments.

FIG. 11 is a block diagram of an example computing device that may perform some or all of the scientific instrument support methods disclosed herein in accordance with various embodiments.

FIG. 12 is a block diagram of an example scientific instrument support system in which some or all of the scientific instrument support methods disclosed herein may be performed, in accordance with various embodiments.

### DETAILED DESCRIPTION

Disclosed herein are scientific instrument support systems, as well as related methods, computing devices, and computer-readable media. In some aspects, a method of mitigating distortion of an optical emission spectrum obtained from an optical emission spectrometer is performed. The optical emission spectrometer comprises an optical system for forming the spectrum, for example the optical emission spectrometer may be an inductively coupled plasma emission spectrometer, which may be configured to record an echelle emission spectrum of light emitted from a plasma. In some embodiments, the spectrometer may be a Raman spectrometer, configured to record a spectrum of inelastically scattered photons; in some embodiments the spectrometer may be an Infrared spectrometer configured to record a spectrum of interaction of infrared radiation interacting with an analyte. For the avoidance of doubt, it will be understood that reference to “light” and “optical” refer to any part of the electromagnetic spectrum, for example, any one or more of the ultraviolet, visible or infrared regions of the electromagnetic spectrum.

A method may comprise obtaining a spectrum recorded with the spectrometer and a respective one or more condition parameters indicative of an operating condition of the optical emission spectrometer or an environment of the optical emission spectrometer at a time of recording the spectrum with the spectrometer and/or a preceding time. For example, in some embodiments, the one or more condition parameters may comprise a parameter indicative of a temperature. The one or more condition parameters indicative of a temperature may comprise, for example, at least one temperature measurement obtained from a temperature sensor attached to a mechanical structure of the optical emission spectrometer. In some embodiments, the one or more condition parameters may comprise a parameter correlated with or indicative of temperature. The one or more condition parameters may comprises one or more of: a parameter indicative of a heating current applied to a heating arrangement for heating and/or stabilizing the temperature of the optical system; a parameter indicative of a temperature of an environment of the spectrometer; a parameter indicative of a temperature of the optical system; a parameter indicative of at least one temperature measurement obtained from a temperature sensor attached to a mechanical structure supporting one or more optical components of the optical system; a parameter indicative of a radio frequency (RF) power of an RF generator for generating a plasma for use in obtaining the emission spectrum; a parameter indicative of a temperature of a power supply of the RF generator; a parameter indicative of a voltage of the power supply of the RF generator; a parameter indicative of a current of the power supply of the RF generator; a parameter indicative of a voltage applied to a heating pad attached to the optical system; a parameter indicative of the current at a control board of the scientific instrument; a parameter indicative of the current at a camera's printed circuit board (PCB); a parameter indicative of the current at an optic's PCB; a parameter indicative of a temperature of one or more components in a PCB; a parameter indicative of whether or not an additional gas option is installed; a parameter indicative of whether or not the plasma is turned on; a parameter indicative of an exhaust pressure of a plasma chamber for containing a plasma for use in obtaining the emission spectrum and a parameter indicative of a temperature of an exhaust tube. In some embodiments, the one or more condition parameters may comprise condition change parameters, indicative of a change of the condition or direction of change of the condition may be provided as part of input data for the model.

It will be understood that, when referring to condition parameters indicative of an operating condition at a time of recording, no particular timing precision is implied. That is, condition parameters obtained at the time of recording influence or contain information on the state of the spectrometer at the time of recording, for example the mechanical configuration of optical components as influenced by environmental and optical system temperatures, that influences distortions in the recorded spectra. Such times “at the time of recording” may therefore somewhat precede or even follow the actual precise time of recording a spectrum, as long as the condition parameters at such times influence or contain information on the distortion of the recorded spectrum relative to a baseline condition.

A method may further comprise providing a machine learning model configured to output, in response to the one or more condition parameters, one or more transform parameters of a transformation to be applied to the obtained spectrum to mitigate distortion of the spectrum due to a discrepancy between the operating condition and a baseline operating condition. For example, in some embodiments, the one or more transform parameters of a transformation may define all or part of the transformation to be applied to the obtained spectrum. For example, in some embodiments, the transformation comprises at least one of: a translation; a rotation; a scaling operation; a centering operation; a normalization operation; a skewing operation; a stretching operation; and a deformation field. The one or more condition parameters may be applied as an input to the machine learning model and one or more transform parameters may be obtained as an output of the machine learning model. Such embodiments allow distortion to be mitigated over a wide range of operating conditions, as a result, useful analytical results may be obtained over a wider range of operating conditions relative to conventional approaches, which require the spectrometer to be operating in a constrained range of stable operating conditions for useful analytical results to be obtained. Typically, reaching this constrained range of stable operating conditions has required running the spectrometer for a significant period of time to allow the operating conditions to stabilize before performing any analysis, wasting energy, time, and expensive consumables like the argon gas used in plasma generation. By enabling the use of a spectrometer over a wider and changing range of operating conditions, this wasteful “start-up” period may be reduced or eliminated. Further, whereas changing operational conditions may have conventionally required analytical results to be “thrown out” (e.g., due to a change in the temperature of the spectrometer room), various ones of the embodiments disclosed herein allow valid and analytically useful spectra to be obtained during these changing conditions, improving throughput and instrument availability. Additionally, since the transform parameters are inferred based on the operating conditions, the described methods avoid the need to fit a transformation for each obtained spectrum, so that distortion mitigation can be done in a computationally efficient manner.

In some embodiments input data for the machine learning model may comprise a time series of one or more condition parameters at each of a plurality of time points. For example, the time series may have a time span of 15 minutes. The number of optical emission spectra obtained throughout the time span of the time series may vary and it is understood that any appropriate number of optical emission spectra may be obtained. For example, in some embodiments, an optical emission spectrum may be obtained at each of the plurality of time points. In the example where the time series is 15 minutes, an optical emission spectrum may be taken at each minute and the one or more condition parameters may be obtained at each minute, or at a higher frequency and a mean, standard deviation, average, slope provided at each time step. In some embodiments, an optical emission spectrum may be obtained at only the last time point, or an arbitrary time point. In some embodiments, no optical emission spectra are obtained within the time span of the time series, and instead an optical emission spectrum is obtained at some predetermined time after the last time point of the time series. The time span of the time series of one or more condition parameters may define any time period prior to or including the last of the one or more time points at which the one or more optical emission spectra are obtained. It is understood that in such embodiments where the input data comprises a time series, the output data may or may not comprise a time series of transform parameters. In some embodiments, the time span comprises time points up to and including a time of obtaining one optical emission spectrum. For example, in some embodiments, the input data comprises a time series of one or more condition parameters at each of a plurality of time points from a pre-determined amount of time (for example 15 minutes) prior to obtaining the optical emission spectrum, up to and including the time of obtaining an optical emission spectrum. In these embodiments, the output data may comprise one or more transform parameters of a transformation to be applied to the one optical emission spectrum. In some embodiments, the input data comprises a time series of one or more condition parameters over a predetermined time span (for example 15 minutes) where at each time point, or at a subset of time points, an optical emission spectrum is obtained. The time series may be used to predict transform parameters as an output at a single time point, in some embodiments. In such embodiments, the one or more condition parameters may further comprise one or more of a mean, standard deviation, maximum-minimum difference or slope of change for the condition parameters, for each time interval prior to an image recording time. For example, [0-1 min, 1-2 min, . . . 14-15 min]. In some embodiments, the output data may comprise a time series of one or more transform parameters at each, or at a subset, of the plurality of time points. In these embodiments, the method may comprise applying the transformation in accordance with the one or more transform parameters at a time point of the obtained instance of output data to an optical emission spectrum obtained at the respective time point. A transform in accordance with respective transform parameters may be applied to the respective spectrum at each time point in the time series.

Since the dependency of spectral distortions on operating conditions can exhibit a degree of hysteresis or history dependence, using the time series of operating conditions as an input can improve the accuracy of the predicted transform parameters. This is because the history dependence can be taken into account by the model, compared to a model using only an instantaneous operating condition, where the temporal information is lost. This is the case whether the output of the model comprises transform parameters at a single time point or at multiple time points. In some embodiments, an element of the history dependency can be accounted for in the input data by including a parameter indicative of a change or a direction of change of the operating condition in the input data, instead or in addition to using a time series as the input.

In some embodiments, the spectrum may be an image and the transformation may comprise an operation that varies across multiple locations in the image, for example, in some embodiments, the operation may comprise applying a distortion field (also known as a warp field) to the image in order to register the image. As a result, a wide range of local distortions can be captured. Compared to global, affine transformations such as translations, rotations and scaling, such a local, non-affine transformation can capture and mitigate a wider range of spectral distortions and hence enable more accurate identification of peaks and corresponding analytes. Specifically, the local transformations can capture functional groups in different parts of the spectrum that are distorted differently, thereby increasing the likelihood of correct identification. Although examples related to spectra represented as digital images are used throughout, it should be understood that the spectra may be represented in any suitable way, for example in terms of a set of identified intensity peaks or troughs and their respective positions, for example the respective two-dimensional coordinates of the intensity peaks in case of an echellogram or other two-dimensional spectrum.

The machine learning model may be any appropriate machine learning model. For example, a random forest or a Gradient Boosting Decision Tree (GBDT) learning algorithm, both of which are models comprising multiple decision trees and employ “bagging” and “boosting” techniques respectively. In one embodiment, an XGBoost algorithm may be used. The XGBoost algorithm is a known decision-tree-based ensemble machine learning algorithm, which, similarly to GBDT uses gradient boosting. XGBoost is presented in the paper: “Chen, T. and Guestrin, C., 2016 August. XGBoost: A scalable tree boosting system. In Proceedings of the 22nd acm sigkdd international conference on knowledge discovery and data mining (pp. 785-794), incorporated here by reference”. A machine learning model, using the XGBoost algorithm, may be trained to provide one or more transform parameters of a transformation to be applied to the obtained spectrum, in response to a time series of one or more condition parameters.

In some embodiments, the machine learning model comprises a feedforward neural network. In embodiments where the input data comprises a time series, the one or more condition parameters at each of the plurality of time points may be applied together as an input to the feedforward neural network. In some embodiments, the machine learning model may comprise a recurrent neural network, for example a LSTM recurrent neural network. In some embodiments, the machine learning model may comprise a transformer model.

In an aspect of the disclosure, a method of training the machine learning model comprises obtaining a training data set comprising training data pairs. Each training data pair comprises a value of the one or more condition parameters for a respective operating condition of the optical emission spectrometer or an environment of the optical emission spectrometer that is different from the baseline operating condition and a respective value of the one or more transform parameters. It will be appreciated that the value of a condition parameter and/or a transform parameter may be a scalar value or a non-scalar value (e.g., a set, vector or other multi-dimensional value). The method comprises a step of adjusting parameters of the machine learning model to reduce a discrepancy between values of the one or more transform parameters of the training data pairs and a value of the one or more transform parameters output by the machine learning model in response to respective values of the one or more condition parameters of the training data pairs. For example, the one or more transform parameters may be a lateral (X-direction) and vertical (Y-direction) transformation and the model may be trained to minimize the mean squared error between the values of the lateral (X-direction) and vertical (Y-direction) transformations of the training data pairs and the lateral (X-direction) and vertical (Y-direction) transformations output by the model. In one embodiment, the model trained to minimize the mean squared error may use XGBoost architecture.

In some aspects of the disclosure, a method of obtaining training data for training the machine learning model comprises recording a plurality of optical emission spectra of a reference analyte with an optical emission spectrometer for respective operating conditions and storing input data for the machine learning model. The input data comprises for each recorded optical emission spectrum one or more parameters indicative of the respective operating condition at a time at which the spectrum was recorded and/or a preceding time. For each recorded optical emission spectrum, one or more transform parameters of a transform to register the optical emission spectrum to a baseline optical emission spectrum using the transform are generated by adjusting the parameters to register the optical emission spectrum to the baseline optical emission spectrum. The baseline optical emission spectrum was recorded for a baseline set of operating conditions, for example the operating conditions recommended by a manufacturer of the spectrometer, for capturing data. The method comprises storing output data for the machine learning model comprising, for each optical emission spectrum, the respective adjusted one or more transform parameters as a training target in association with the respective input data for each optical emission spectrum as a training data pair. It will be appreciated that the training data may be generated with the same or a different spectrometer than the one used for recording the baseline spectrum. Likewise, the training data may comprise spectra recorded with different respective spectrometers, which may facilitate generalization of the model across different spectrometers. Preferably, the spectrometers used to generate the training data are of the same type as the spectrometer whose spectra will be adjusted by the trained model, for example the same make and/or model, but in some embodiments, the spectrometers used to generate the training data are of a different make and/or model as the spectrometer whose spectra will be adjusted by the trained model. In some embodiments, the same spectrometer is used to generate the training data. This may facilitate generating a model specific to that spectrometer, which may result in higher accuracy for that spectrometer.

The scientific instrument support embodiments disclosed herein may achieve improved performance relative to conventional approaches. For example, whilst distortion of optical spectra due to temperature variation is a common problem, conventional methods use peaks that appear in both a reference and sample spectrum, for example a Carbon peak, in order to calculate distortion from the expected position of the peak. Identified locations of an unknown peak in the same sample spectrum can then be shifted using the determined drift. In some embodiments of the present disclosure, the spectra are images and adjusting one or more transform parameters to register the spectra may comprise comparing the intensities between the images. Such embodiments do not require the identification of peaks. Since there is no requirement for peaks to be correctly identified, the resulting method can be more flexible and accurate due to taking into account the image as a whole as opposed to only identified peaks. The embodiments disclosed herein thus provide improvements to scientific instrument technology (e.g., improvements in the computer technology supporting such scientific instruments, among other improvements).

The aspects and embodiments disclosed herein may achieve a more flexible transformation by capturing a wider range of distortions relative to conventional approaches. For example, conventional approaches rely on the identification of a peak that appears in both the reference and sample spectrum and hence becomes difficult to implement when none of the peaks have a clearly identifiable position. In addition, these approaches suffer from a number of technical problems and limitations, arising due to the offset being linearly applied to the entirety of the spectrum, which is particularly pertinent for echelon or full-frame spectra.

Various ones of the aspects and embodiments disclosed herein, for example embodiments wherein the adjusting of the transform parameters provided in the method of providing training data for a machine learning model may comprise comparing the intensities between the two images, may improve upon conventional approaches to achieve the technical advantages of mitigating distortion without the requirement of finding a peak. Such technical advantages are not achievable by routine and conventional approaches, and all users of systems including such embodiments may benefit from these advantages (e.g., by assisting the user in the performance of a technical task, such as providing a larger range of temperatures at which spectra can be obtained since there is no requirement for identifiable peaks). The technical features of the embodiments disclosed herein are thus decidedly unconventional in the field of spectroscopy, as are the combinations of the features of the embodiments disclosed herein. The computational and user interface features disclosed herein do not only involve the collection and comparison of information but applying new analytical and technical techniques to change the operation of a machine learning model used in this field. The present disclosure thus introduces functionality that neither a conventional computing device, nor a human, could perform.

Accordingly, the embodiments of the present disclosure may serve any of a number of technical purposes. These technical purposes include: controlling a specific technical system or process; determining from measurements how to control a machine; enhancement of analysis; reducing the amount of sensor data to be processed or providing a faster processing of sensor data, the latter two at least partially due to the elimination of the requirement for peak identification in order to mitigate distortion of a spectrum. In particular, the present disclosure provides technical solutions to technical problems, including but not limited to providing more flexible transformations which capture a wide range of local distortions and removing the requirement for identifying spectral peaks when analyzing spectra and as a result reducing the computational requirement at inference. Further technical solutions include providing an instrument that can be used under virtually any operating conditions (for example temperature) and consequently reducing the amount spent on costly argon gas for use in plasma because useful spectra can be obtained prior to the operating conditions stabilizing at baseline operating conditions. The embodiments disclosed herein thus provide improvements to analytical technology (e.g., improvements in the computer technology supporting chemical analysis, among other improvements).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (Band C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

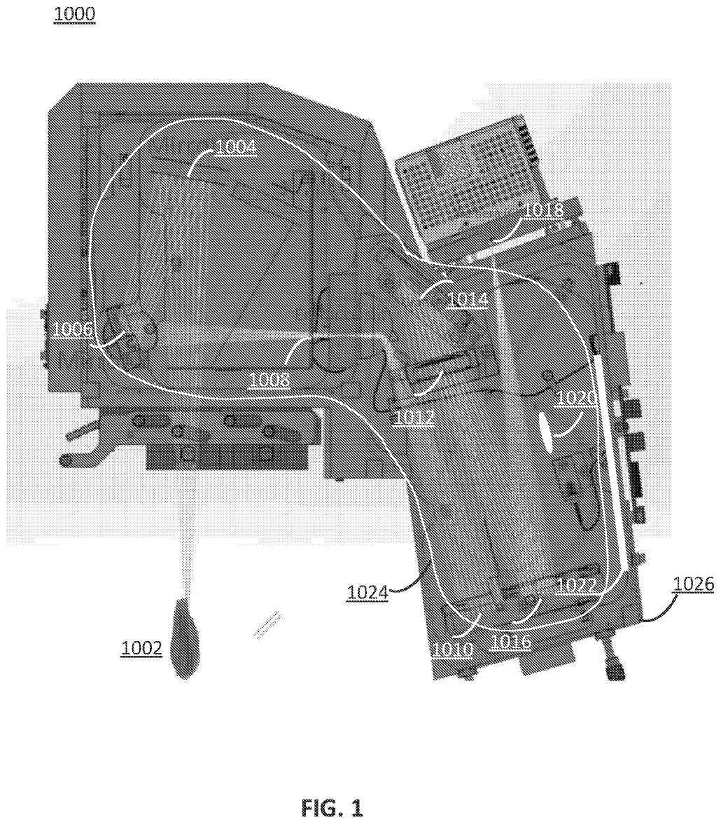

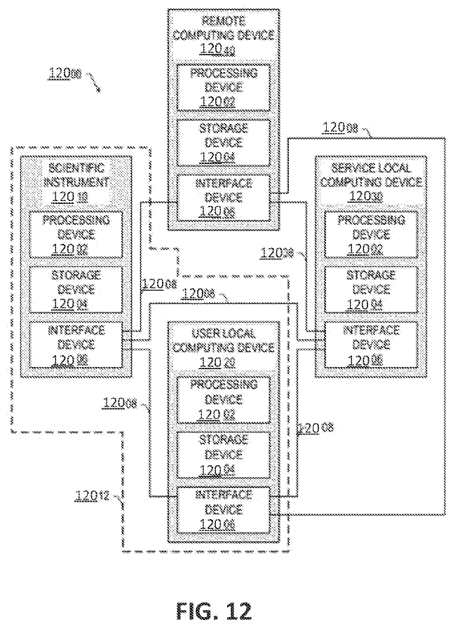

FIG. 1 is a diagram of an example of an Inductive Coupled Plasma Optical Emission Spectrometer (ICP-OES) 1000 or obtaining optical emission spectra in accordance with various embodiments. The ICP-OES 1000 may be a component in a scientific support system 1200, for example, as described below with reference to FIG. 12. Emission spectrometers operate by exciting atoms and ions to emit electromagnetic (EM) radiation at wavelengths characteristic of a particular element. A spectrum of frequencies of EM radiation is emitted due to an electron making a transition from a high energy state to a lower energy state. The ICP-OES 1000 may comprise a plasma chamber 1002. The plasma chamber 1002 may be connected to a radio frequency (RF) source and a source of gas, for example argon gas. The argon gas may be ionized inside an oscillating RF field produced by the RF source to develop and maintain plasma inside the plasma chamber 1002. The ICP-OES 1000 may be of an echelle-based optical design to produce a two-dimensional optical emission spectrum.

Specifically, the ICP-OES may comprise an echelle diffraction grating 1014, a prism 1012 and multiple focusing mirrors 1004, 1006, 1010, 1016. Collectively, these components provide an optical system 1024. Light from the plasma chamber 1002 enters the ICP-OES 1000 and is selectively focused using multiple focusing mirrors, for example a first 1004 and second 1006 mirror. The focused light may be passed through an entrance slit 1008 and into the prism 1012 using the mirror 1010. The prism 1012 may separate the light by wavelength. The echelle diffraction grating 1014 may diffract the separated light from the prism 1012 into multiple diffraction orders, creating a high-resolution 2D spectrum known as an echellogram, also referred to as full-frame or echelle spectrum. After passing through these optical elements, the mirror 1016 may collect and focus the spectrum onto a detector, for example the camera 1018. The optical system is housed inside a housing 1026. One or more heating pads 1022 may be located on an outside surface of the housing 1026 to allow the temperature of the optical system 1024 to be controlled and kept stable at a baseline operating temperature by heating the optical system 1024 and/or its environment inside the housing 1026. A temperature sensor 1020 may indicate the temperature of, for example, an environment of the optical emission spectrometer. In one embodiment, the temperature sensor 1020 may indicate the temperature of the optical emission spectrometer, or the optical system of the optical emission spectrometer comprising the optical components. Advantageously, the temperature sensor 1020 may be disposed on a mechanical structure supporting one or more of the optical components to better capture variations in temperature affecting the configuration of the optical components and hence the alignment of the spectra. A second temperature sensor may be located away from the optical system 1024, but in some embodiments, may still be located inside the instrument. The second temperature sensor may provide an ambient temperature measurement. The number, identity and location of the components described above with reference to FIG. 1 are used illustratively and it is understood that other configurations and/or optical components may be used. Although the embodiments are described with reference to an inductive coupled plasma optical emission spectrometer, they are equally applicable to other types of spectra obtained with other types of spectrometers. For example, the methods described herein may be used for similar spectroscopic techniques such as inductively coupled plasma mass spectrometry (ICP-MS) and atomic absorption spectrometry (AAS) and, indeed, may be applied to any method of obtaining spectra, where the spectra are dependent on an operating condition of the spectrometer. Various embodiments include the use of spectroscopic techniques such as Rayleigh, Raman or Mass spectrometry.

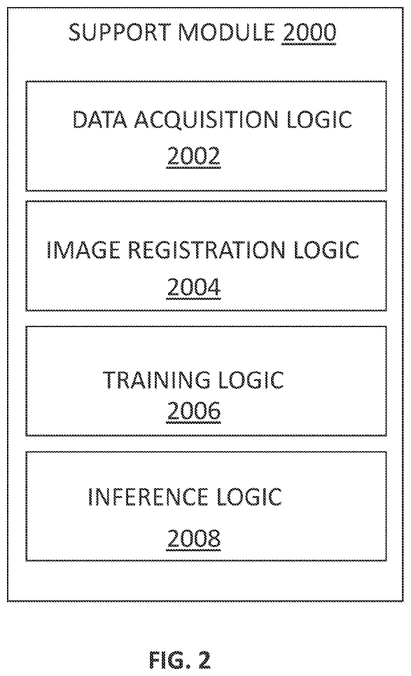

FIG. 2 is a block diagram of a scientific instrument support module 2000 for performing support operations for a spectrometer such as the one described with reference to FIG. 2, in accordance with various embodiments. The scientific instrument support module 2000 may be implemented by circuitry (e.g., including electrical and/or optical components), such as a programmed computing device. The logic of the scientific instrument support module 2000 may be included in a single computing device or may be distributed across multiple computing devices that are in communication with each other as appropriate. Examples of computing devices that may, singly or in combination, implement the scientific instrument support module 2000 are discussed herein with reference to a computing device 11000 of FIG. 11, and examples of systems of interconnected computing devices, in which the scientific instrument support module 2000 may be implemented across one or more of the computing devices, is discussed herein with reference to the scientific instrument support system 12000 of FIG. 12.

The scientific instrument support module 2000 may include a data acquisition logic 2002, an image registration logic 2004, a training logic 2006 and an inference logic 2008. As used herein, the term “logic” may include an apparatus that is to perform a set of operations associated with the logic. For example, any of the logic elements included in the support module 2000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module. A specific arrangement of logic elements and modules is described but it will be understood that the corresponding functionality may be implemented and partitioned in many other ways.

The data acquisition logic 2002 may be configured to control the ICP-OES 1000 to acquire data for use by, for example, the training 2006 or inference logic 2008. The data acquisition logic 2002 may be configured to control the ICP-OES 1000 to alter an operating condition of the ICP-OES 1000, for example by controlling the heating pad 1022.

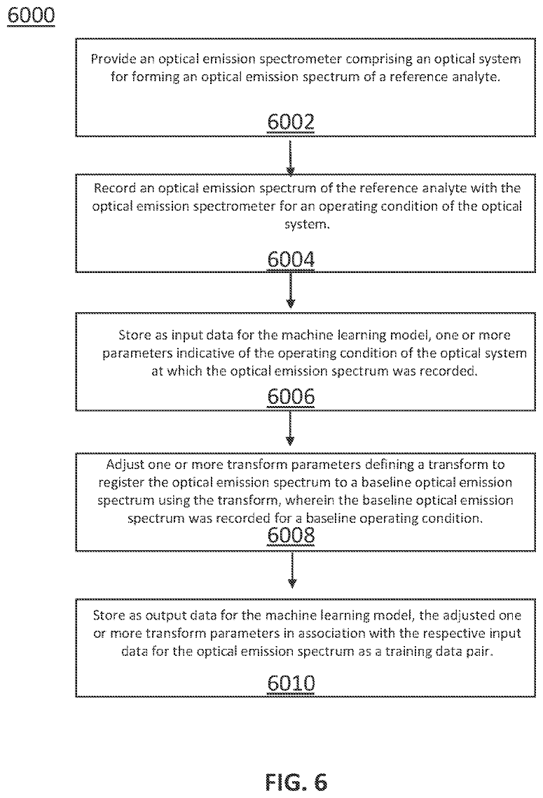

For example, the data acquisition logic 2002 may control the operating conditions of the ICP-OES to correspond to specific predetermined baseline operating conditions for obtaining a baseline spectrum. For example, in order to obtain a baseline spectrum, the data acquisition logic 2002 may be configured to maintain operating conditions of the optical components at a stable temperature of 38 degrees Celsius for a pre-determined amount of time. For example, in one embodiment, the data acquisition logic 2002 may be configured to maintain the operating conditions of the optical components at a stable temperature for 30 minutes before acquiring a baseline spectrum. In some embodiments, multiple spectra may be acquired within the pre-determined amount of time, for example, at a rate of one spectrum per second. The data acquisition logic may compare one or more of the spectra acquired at the baseline operating condition to confirm the absence of, or confirm a negligible (for example 0.5 pixel in 30 minutes) amount of drift at the baseline operating condition. Upon confirmation of either an absence of drift, or a negligible amount of drift, the data acquisition logic 2002 may use any one of the spectra obtained at the baseline operating conditions as the baseline spectrum. The data acquisition logic 2002 may be configured to alter the operating condition to multiple specific predetermined operating conditions for obtaining training data, as described in more detail below with reference to FIG. 6. For example, the data acquisition logic 2002 may, for example, alter the operating conditions by cycling through multiple temperature settings using the heating pad 1022 whilst periodically acquiring spectra, for example one spectrum per second. The data acquisition logic may simultaneously or sequentially alter the RF power supplied to the plasma chamber 1002 in order to alter the operating conditions of the optical system, this may include setting the RF power to alternate between high, for example 1500 W, and low, for example 1150 W, settings over a predetermined time period, for example 2 minutes, Sequentially cycling both the temperature supplied by the heating pad 1022 and the RF generator allows increased thermal regulation of the optical system of the ICP-OES 1000 since plasma heat is one or the major disrupters of thermal equilibrium of the optical system.

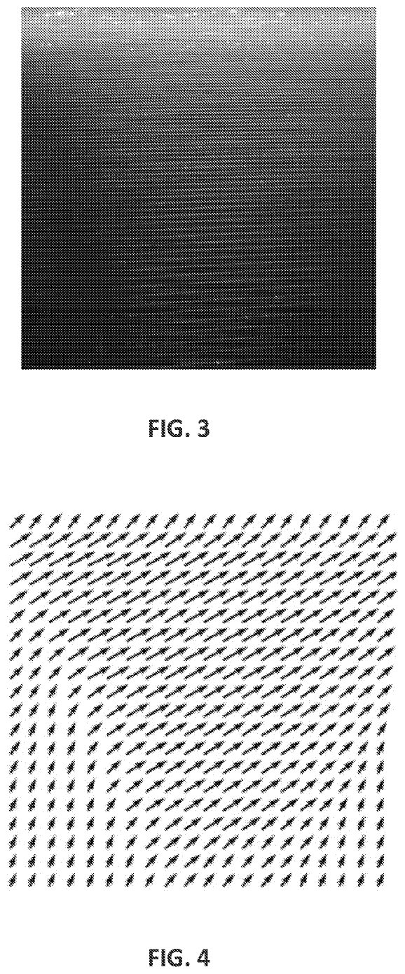

The data acquisition logic 2002 may be configured to acquire and store spectral data and corresponding operating condition data. FIG. 3 depicts an example full-frame spectrum or echellogram of the intensity distribution captured by the photo detector 1018 on ICP-OES 1000, in accordance with some embodiments. Multiple peaks are seen as white dots of varying intensities, as shown by FIG. 3. Each peak of the multiple peaks may have characteristic intensity and wavelength indicative of a specific atom or molecule. The intensity distribution captured by the photo detector 1018 may be captured and stored by the data acquisition logic 2002 in the form of a digital image comprising a collection of pixels with pixel values reflecting the captured intensity distribution. The pixel values may be grey-scale scalar values or vector values representing color information.

The data acquisition logic 2002 may be configured to perform checks upon initializing the ICP-OES 1000 and may further be configured to apply known background correction techniques prior to obtaining spectra. The data acquisition logic 2002 may perform standard sample preparation related operations, standard data quality control operations as well as any standard data acquisition operations and further may control sample introduction to the spectrometer as well as the exposure time of an analyte to the plasma in accordance with the concentration of the analyte as per standard operating procedures.

The image registration logic 2004 may be configured register images of obtained spectra, also referred to as spectral images in order in order to generate transform parameters of a transform that registers acquired spectral images to a baseline spectral image. The image registration logic 2004 may be configured to retrieve an image of a baseline spectrum stored by the data acquisition logic 2002 and an image of an obtained spectrum stored by the data acquisition logic 2002 and perform image registration. In some embodiments, the image registration logic 2004 may be configured to perform image registration based on identified local points of the spectrum as landmarks, such as of peaks of the spectrum. In these embodiments, the transform parameters are adjusted to minimize a positional error between landmarks in the obtained and baseline spectra when the corresponding transform is applied to the obtained image. In other embodiments, the image registration logic 2004 may be configured to perform image registration of an entire image of the spectrum, such as the full-frame spectrum shown in FIG. 3, for example based on comparing image intensities for all pixels or a set of control points between the obtained and baseline spectra.

The image registration logic 2004 may thus determine transform parameters of a transform to register the obtained optical emission spectrum to the baseline optical emission spectrum. The transform may be an affine transformation, such as a combination of translation and rotation operations globally applied to the obtained image or the transformation may be non-affine and apply local transformations, for example by way of a distortion or warp field as is known in the field of image registration. The image registration logic 2004 may perform image registration using any appropriate known method. For example, in one embodiment, the image registration logic 2004 may comprise an Adversarial Similarity Network [Adversarial Similarity Network for Evaluating Image Alignment in Deep Learning Based Registration Jingfan Fan, Xiaohuan Cao, Zhong Xue, Pew-Thian Yap, and Dinggang Shen, Med Image Comput Comput Assist Interv. 2018 September; 11070:739-746. doi: 10.1007/978-3-030-00928-1_83. Epub 2018 Sep. 26. PMID: 30627709; PMCID: PMC6322551, incorporated herein by reference] which is known for use in estimating image warping/shifting for medical purposes.

An example of a warp field for registering an obtained spectrum to a baseline spectrum is depicted in FIG. 4. The warp field defines local transformations indicated by the arrows that align local intensity distributions in the respective images and are hence illustrative not only of a particular type of transformation used in some embodiments but also illustrate the distortions that can arise due to varying operating conditions. Typically, such distortions arise due to varying operating conditions that may be indicative of the temperature of the optical system, or correlated with the temperature of the optical system.

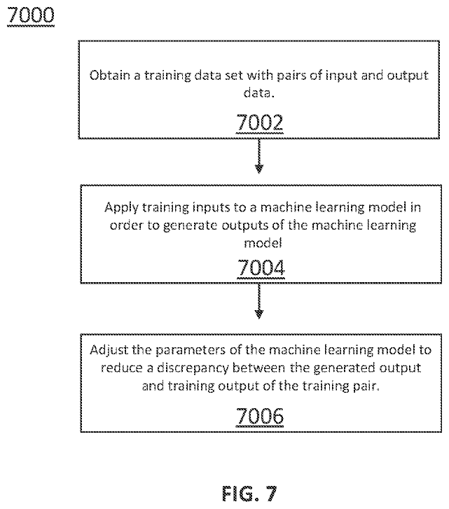

The training logic 2006 may be configured to perform a training process 7000 to generate a machine learning model that produces transform parameters in response to an input of parameters describing operating conditions of the optical emission spectrometer 1002, as described in detail below with reference to FIG. 7, using training data acquired by the data acquisition logic 2004.

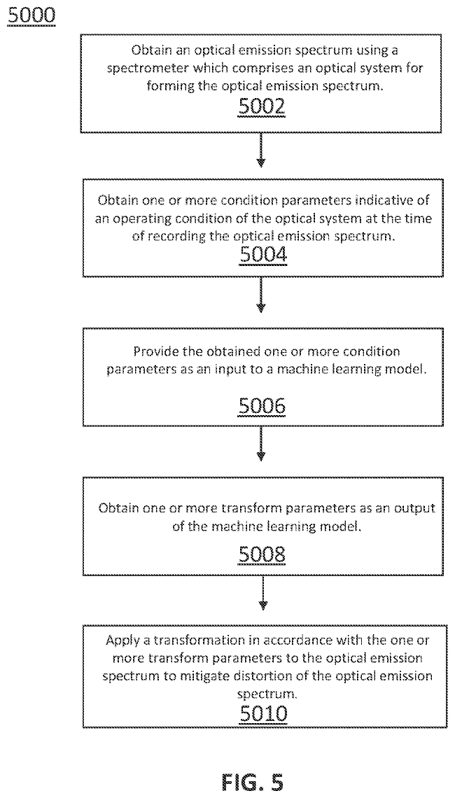

The inference logic 2008 may be configured to perform an inference process 5000 to generate transform parameters and apply a corresponding transform to an obtained spectrum to mitigate operating condition related distortion in the obtained spectrum, as described in detail below with reference to FIG. 5.

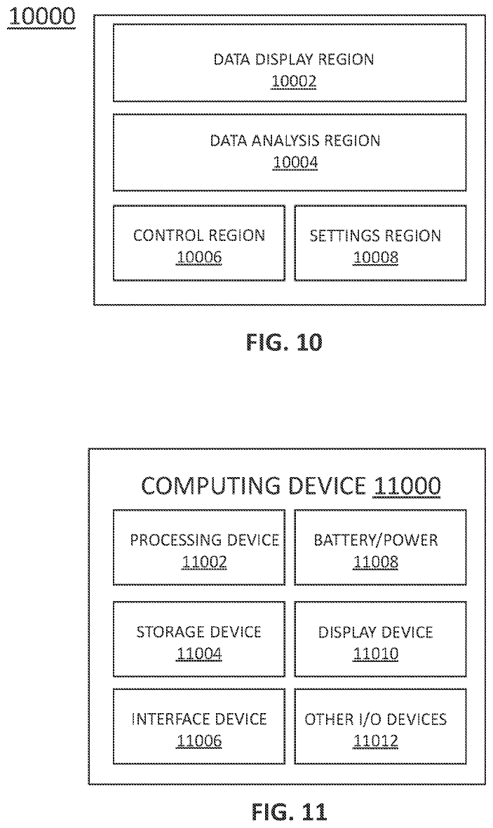

FIG. 5 is a flow diagram of an inference method 5000 of mitigating distortion of an optical emission spectrum, in accordance with various embodiments. The steps of this process may be carried out, for example by the inference logic 2008. Although the operations of the method 5000 may be illustrated with reference to particular embodiments disclosed herein (e.g., the scientific instrument support modules 2000 discussed herein with reference to FIG. 2, a graphical user interface (GUI) 10000 discussed herein with reference to FIG. 10, the computing devices 11000 discussed herein with reference to FIG. 11, and/or the scientific instrument support system 12000 discussed herein with reference to FIG. 12), the method 5000 may be used in any suitable setting to perform any suitable support operations. Operations are illustrated once each and in a particular order in FIG. 5, but the operations may be reordered and/or repeated as desired and appropriate (e.g., operations may be performed in parallel, as suitable).

At 5002, first operations may be performed. The first operations may comprise obtaining an optical emission spectrum using a spectrometer which comprises an optical system for forming the optical emission spectrum. The spectrometer may be the ICP-OES 1000, described above with reference to FIG. 1. The spectrum may be, for example, a full-frame, as shown in FIG. 3. The spectrum may be obtained while the spectrometer is operating in a stable operating condition, for example the baseline operating condition, or at other times. For example, disclosed methods enable spectra to be usefully obtained while the spectrometer warms up to reach baseline operating conditions. This is because disclosed methods allow for correction or at least mitigation of operating condition related distortions, such as thermal distortions, while the spectrometer reaches baseline operating conditions following switch-on. As a result, spectra become useable more quickly and consumption of electricity and other consumables can be reduced.

At 5004, second operations may be performed. The second operations may comprise obtaining one or more condition parameters indicative of an operating condition of the optical emission spectrometer or an environment of the optical emission spectrometer at, the time of recording the optical emission spectrum and/or a preceding time. For example, in some embodiments, the one or more condition parameters may be indicative of an operating condition of the optical system, the operating condition may be indicative of the temperature of the optical system or correlated with the temperature of the optical system. The condition parameters may include one or more of an optics temperature, an RF voltage, an RF current, an optics heater voltage and an ambient temperature board readback. In some embodiments, the one or more condition parameters may be a time series of one or more condition parameters at each of a plurality of time points, for example, a plurality of time points for the 15 minutes up to and including a time of obtaining the optical emission spectrum. In some embodiments, where more than one condition parameter is obtained, the condition parameters may be obtained over different time spans. For example, the input data may comprise a time series of one or more condition parameters at each of a plurality of time points for the 15 minutes up to and including a time of obtaining the optical emission spectrum and of one or more other condition parameters at each of a plurality of time points for the 5 minutes up to and including a time of obtaining the optical emission spectrum.

At 5006, third operations may be performed. The third operations may comprise providing the obtained one or more condition parameters as an input to a machine learning model. For example, in some embodiments, a machine learning model, using the XGBoost algorithm may be used. In some embodiments, the machine learning model comprises a feedforward neural network. In embodiments where the input data comprises a time series, the one or more condition parameters at each of the plurality of time points may be applied together as an input to the feedforward neural network. In some embodiments, the machine learning model may comprise a recurrent neural network, for example including USTM units. In some embodiments, the machine learning model may comprise a transformer model. The machine learning model may have been trained according to the process described below with reference to FIG. 7, for example.

At 5008, fourth operations may be performed. The fourth operations may be to obtain one or more transform parameters as an output of the machine learning model.

At 5010, fifth operations may be performed. The fifth operations may be to apply a transformation in accordance with the one or more transform parameters to the obtained optical emission spectrum to mitigate distortion of the optical emission spectrum. As discussed above, mitigating distortions due to varying operating conditions allows useful spectra to be collected more quickly without having to wait for operating conditions to stabilise.

FIG. 6 is a flow diagram of an example data collection method 6000 of obtaining training data for training the machine learning model used in the inference method 5000, in accordance with various embodiments. Unlike in conventional operating mode, where the system is left to within a constrained range of stable operating conditions prior to data collection, training data is obtained at a wide range of operating conditions. The steps of this process may be carried out, for example by the data acquisition logic 2002 and image registration logic 2004. Although the operations of the data collection method 6000 may be illustrated with reference to particular embodiments disclosed herein (e.g., the scientific instrument support modules 2000 discussed herein with reference to FIG. 2, the GUI 10000 discussed herein with reference to FIG. 10, the computing devices 11000 discussed herein with reference to FIG. 11, and/or the scientific instrument support system 12000 discussed herein with reference to FIG. 12), the method 6000 may be used in any suitable setting to perform any suitable support operations. Operations are illustrated once each and in a particular order in FIG. 6, but the operations may be reordered and/or repeated as desired and appropriate (e.g., operations may be performed in parallel, as suitable).

At 6002, first operations may be performed. The first operations may comprise providing a spectrometer comprising an optical system for forming an optical emission spectrum of a reference analyte. The spectrometer may be the ICP-OES 1000, described above with reference to FIG. 1.

At 6004, second operations may be performed. The second operations may comprise recording an optical emission spectrum of a reference analyte for an operating condition of the optical emission spectrometer or an environment of the optical emission spectrometer. For example, in one embodiment, the second operation may comprises recording an operating condition of the optical system of the optical emission spectrometer.

At 6006, third operations may be performed. The third operations may comprise storing as input data for the machine learning model, one or more parameters indicative of the operating condition of the optical system at which the optical emission spectrum was recorded.

At 6008, fourth operations may be performed. The fourth operations may comprise adjusting one or more transform parameters of a transform to register the optical emission spectrum to a baseline optical emission spectrum using the transform, as described above with reference to the image registration logic 2004. The baseline optical emission spectrum may be recorded for a baseline operating condition when the spectrometer is in a stable baseline operating condition, for example, by data acquisition logic 2002. For example, in some embodiments, the baseline optical emission spectrum may be recorded on the same spectrometer as the optical emission spectrum to be registered. In some embodiments, the baseline optical emission spectrum may be an industry standard baseline spectrum obtained from a third party.

At 6010, fifth operations may be performed. The fifth operations may comprise storing as output data for the machine learning model, the adjusted one or more transform parameters in association with the respective input data for the optical emission spectrum as a training data pair.

After 6010, the method 6000 may cycle back to 6004 and perform the operations 6004-6010 under different respective operating conditions for each cycle, thereby recording training data pairs for different operating conditions For example, data acquisition logic 2002 may be used to obtain multiple spectra with multiple corresponding operating condition. Alternatively, operations 6004-6008 may be performed as a series of cycles, each time under a different respective operating condition, and step 6010 performed subsequently in batch for all spectra to form the training data pairs. In either case, the cycles may all be performed on the same spectrometer, or the cycles may be performed using different spectrometer, for example obtaining a training data pair for each of a plurality of operating conditions from each of a plurality of spectrometers of the same type, for example the same make and model.

FIG. 7 is a flow diagram of an example training method of training the machine learning model for use in the inference method 5000, in accordance with various embodiments. Any suitable machine learning model may be used and trained in accordance with various embodiments, for example, a machine learning model, using the XGBoost algorithm may be used. The steps of this process may be carried out, for example by the training logic 2006. Although the operations of the method 5000 may be illustrated with reference to particular embodiments disclosed herein (e.g., the scientific instrument support modules 2000 discussed herein with reference to FIG. 2, the GUI 10000 discussed herein with reference to FIG. 10, the computing devices 11000 discussed herein with reference to FIG. 11, and/or the scientific instrument support system 12000 discussed herein with reference to FIG. 12), the method 5000 may be used in any suitable setting to perform any suitable support operations. Operations are illustrated once each and in a particular order in FIG. 7, but the operations may be reordered and/or repeated as desired and appropriate (e.g., operations may be performed in parallel, as suitable).

At 7002, first operations may be performed. The first operations may comprise obtaining a training data set with training data pairs of input and output data, for example as described above with reference to FIG. 6 and data acquisition method 6000.

At 7004, second operations may be performed. The second operation may comprise applying training inputs to a machine learning model in order to generate outputs of the machine learning model.

At 7006, third operations may be performed. The third operation may comprise adjusting the parameters of the machine learning model to reduce a discrepancy between the generated output and training output of the training pair. Operations 7002-7006 are performed for all training data pairs in the training data sets and the parameters may be adjusted in multiple passes or epochs of the training data set, for example until a stopping criterion indicating satisfactory outputs is met. For example, the stopping criteria may be a test error between actual and target outputs evaluated on a test data set separate from the training data set. In some embodiments, the test error is evaluated using n-fold, for example 5-fold cross-validation.

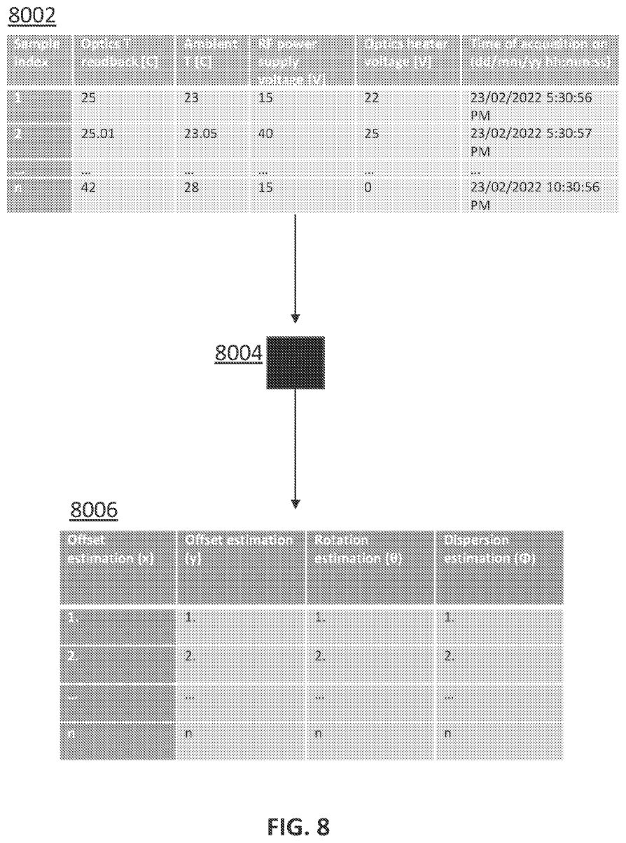

FIG. 8 shows an example of input data 8002 provided to a machine learning model 8004 and an example of an output data 8006 that the model is trained to provide, in accordance with various embodiments. The input data 8002 may be obtained, for example, using data acquisition logic 2002, in some embodiments in accordance with data acquisition method 6000. The output data 8004 may be obtained, for example, using image registration logic 2004. The number and type of parameters depicted in FIG. 8 are purely illustrative and any appropriate number or type of parameters may be included as the input data 8002 and the output data 8006.

The input data 8002 is indicative of one or more parameters of an operating condition of the optical system of the spectrometer used to record a spectrum. For example, in some embodiments, the one or more parameters may be indicative of, or correlated to, the temperature of the optical system. The input data 8002 may comprise, for example, a sample index which indicates the corresponding full-frame, an optics temperature readback indicating the temperature of the optical system at the moment of acquisition and an ambient temperature measurement obtained by a sensor placed on the instrument control board away from the optical tank but still inside the instrument. The sample index may be used for data management only and may not be input to the model in some embodiments. The input data may further comprise an RF power supply (Voltage), which along with the RF power supply current gives a direct estimation of the power supplied to the plasma and its equivalent temperature. The plasma temperature strongly affects the temperature of the optical system and can therefore provide further useful information to the machine learning model. The input data may further comprise an optics heater voltage indicating the voltage value set by the thermal stabilization routine that evaluates the absolute value and the speed of change of the optics temperature readback to control the temperature of the optical system and hence provides an indication of a rate of change of the temperature of the optical system. The input data may further comprise the time of acquisition which contains information on the rate of change of temperature in conjunction with the temperature information. In some embodiments, the time of acquisition and temperature information may be used to compute a rate of change of the temperature of the optical system as a further input to the machine learning model. In some embodiments, the input data includes a time series of the condition parameters, that is several samples of the condition parameters at respective different acquisition times applied to the inputs as described below.

The machine learning model 8004 may be any appropriate model trained to provide the output data 8006 in response to the input data 8002. To handle input data as a time series, the machine learning model, in some embodiments, may comprise a recurrent neural network or a transformer model. In some embodiments, the machine learning model may comprise a XGBoost algorithm. In such embodiments the model may be trained to provide one or more transform parameters of a transformation to be applied to the obtained spectrum, in response to a time series of one or more condition parameters. In some embodiments, the machine learning model may comprise a feedforward neural network. In some embodiments, the feedforward neural network is adapted to handle time series input data by providing an input unit for condition parameter at each time step of the time series. In such embodiments, a sample number and/or time stamp may not be included in the input data, as the identity of each input unit indicates a corresponding time step (and parameter).

The output data 8006 is indicative of one or more transform parameters of a transformation defined in terms of the transform parameters for registering the optical emission spectrum to a baseline optical emission spectrum, as described above. In embodiments where the input to the machine learning model comprises a time series of condition parameters, the output comprises a corresponding time series of transform parameters of a corresponding transform for the respective spectrum at each time step.

The scientific instrument support methods disclosed herein may include interactions with a human user (e.g., via the user local computing device 12020 discussed below with reference to FIG. 12 FIG. 12). These interactions may include providing information to the user (e.g., information regarding the operation of a scientific instrument such as the scientific instrument 12010 of FIG. 12, information regarding a sample being analyzed or other test or measurement performed by a scientific instrument, information retrieved from a local or remote database, or other information) or providing an option for a user to input commands (e.g., to control the operation of a scientific instrument such as the scientific instrument 12010 of FIG. 12, or to control the analysis of data generated by a scientific instrument), queries (e.g., to a local or remote database), or other information. In some embodiments, these interactions may be performed through a graphical user interface (GUI) that includes a visual display on a display device (e.g., the display device 11010 discussed herein with reference to FIG. 11) that provides outputs to the user and/or prompts the user to provide inputs (e.g., via one or more input devices, such as a keyboard, mouse, trackpad, or touchscreen, included in the other I/O devices 11012 discussed herein with reference to FIG. 11). The scientific instrument support systems disclosed herein may include any suitable GUIs for interaction with a user.

FIG. 10 depicts an example GUI 10000 that may be used in the performance of some or all of the support methods disclosed herein, in accordance with various embodiments. As noted above, the GUI 10000 may be provided on a display device (e.g., the display device 11010 discussed herein with reference to FIG. 11) of a computing device (e.g., the computing device 11000 discussed herein with reference to FIG. 11) of a scientific instrument support system (e.g., the scientific instrument support system 12000 discussed herein with reference to FIG. 12), and a user may interact with the GUI 10000 using any suitable input device (e.g., any of the input devices included in the other I/O devices 11012 discussed herein with reference to FIG. 11) and input technique (e.g., movement of a cursor, motion capture, facial recognition, gesture detection, voice recognition, actuation of buttons, etc.). The GUI 10000 may include a data display region 10002, a data analysis region 10004, a scientific instrument control region 10006, and a settings region 10008. The particular number and arrangement of regions depicted in FIG. 10 is simply illustrative, and any number and arrangement of regions, including any desired features, may be included in a GUI 10000. The data display region 10002 may display data generated by a scientific instrument (e.g., the scientific instrument 12010 discussed herein with reference to FIG. 12 FIG. 12). For example, the data display region 10002 may display one or more optical emission spectra obtained from the optical emission spectrometer, for example as illustrated in FIG. 3. The data display region 10002 may further display one or more operating conditions of the optical system of spectrometer 1000. The data analysis region 10004 may display the results of data analysis (e.g., the results of analyzing the data illustrated in the data display region 10002 and/or other data).

For example, the data analysis region 10004 may display one or more transform parameters of a transform to register the optical emission spectrum to a baseline optical emission spectrum using a transform, In some embodiments, the data display region 10002 and the data analysis region 10004 may be combined in the GUI 10000 (e.g., to include data output from a scientific instrument, and some analysis of the data, in a common graph or region). The scientific instrument control region 10006 may include options that allow the user to control a scientific instrument (e.g., the scientific instrument 12010 discussed herein with reference to FIG. 12 FIG. 12). For example, the scientific instrument control region 10006 may include temperature controls and RF controls. The settings region 10008 may include options that allow the user to control the features and functions of the GUI 10000 (and/or other GUIs) and/or perform common computing operations with respect to the data display region 10002 and data analysis region 10004 (e.g., saving data on a storage device, such as the storage device 11004 discussed herein with reference to FIG. 11, sending data to another user, labeling data, etc.). For example, the settings region 10008 may include the option to save spectra upon obtaining the spectra or the option to set a certain temperature or RF power supply voltage.

### EXAMPLE IMPLEMENTATION

In the example implementation described below, training data was obtained from two different types of optical emission spectrometer: a Thermo Scientific™ iCAP™ PRO ICP-OES model and an iCAP™ PRO X ICP-OES. For each optical emission spectrometer, a baseline spectrum of a reference analyte of the composition: [Al: 1 mg/L, Ba: 0.2 mg/L, Ca: 0.2 mg/L, Cu: 1 mg/L, K: 5 mg/L, Mn: 1 mg/L, Ni: 5 mg/L, Pm: 10 mg/L, Zn: 0.2 mg/L, Mg: 0.2 mg/L, Other: 0.2% HNO₃ mg/L] was obtained at baseline operating conditions. The baseline operating conditions were maintained for 30 minutes prior to obtaining the baseline spectra. The baseline operating conditions at which the baseline spectra were obtained comprised: an optical system temperature of 38 degrees Celsius and an RF power of 1150 W.

The condition parameters indicative of operating conditions were collected at a sampling frequency of 0.1 Hz.

The condition parameters comprised:
a parameter indicative of whether or not the user has pressed a button to initiate the plasma being generated (0,1);
a parameter indicative of the temperature of the optical system, obtained from a temperature sensor attached to a mechanical structure supporting one or more optical components of the optical system (Celsius);
a parameter indicative of the change in temperature of the optical system (Celsius);
a parameter indicative of a temperature around the scientific instrument obtained from a temperature sensor attached to a mechanical structure away from the optical system (Celsius);
a parameter indicative of a temperature on a power supply of the RF generator connected to plasma chamber 1002 (Celsius);
a parameter indicative of a temperature of a printed circuit board controlling a heating pad of the optical system (Celsius);
a parameter indicative of a voltage on a power supply of the RF generator connected to plasma chamber 1002 (V);
a parameter indicative of a current on a power supply of the RF generator connected to plasma chamber 1002 (A);
a parameter indicative of a voltage applied to an optical system heating pad (V);
a parameter indicative of a pressure in an exhaust tube used to aspirate exhaust plasma gases (mBar);
a parameter indicative of a temperature of the exhaust tube used to aspirate exhaust plasma gases (Celsius);
a parameter indicative of the operation of a drain of ( )(1/s)
a parameter indicative of the current at a control board of the spectrometer (A);
a parameter indicative of the current at a camera's PCB (A);
a parameter indicative of the current at a circuit board of the optical system (including heating pads, shutter, slit) (A);

The training data was obtained by modifying the operating conditions of the optical emission spectrometer whilst obtaining spectra. Training data was obtained from 15 optical emission spectrometers within 10 hours of the respective optical emission spectrometers being turned on. Test and validation data was obtained from different optical emission spectrometers in order to provide an unbiased evaluation of model performance. Validation data was obtained from an additional 3 optical emission spectrometers and Test data was obtained from a further 4 optical emission spectrometers. The spectra were obtained at a high power conditions and at low power conditions by setting the RF power source connected to the plasma chamber 1002 to a high or low power. This was achieved using two methods. The first, by running an entire experiment at either a high (1500 W) or low power (1150 W) setting. The second, by setting the RF power source connected to the plasma chamber 1002 to alternate between 1500 W and 1150 W settings. The rate of cycling between RF power differed between training samples and included, for example, alternating between high and low power every 2 minutes. The spectra were obtained at a sampling frequency of 1 spectrum/min. For each obtained spectra, the drift in the lateral (X) or vertical (Y) direction from the baseline spectrum were computed by applying a classic peak detection algorithm and were recorded as the one or more transform parameters of a transformation.

The one or more transform parameters were provided to a machine learning model. In an example implementation an XGBoost model was used, however, it is understood that any appropriate machine learning model could be used, such as an recurrent neural network or a transformer model. The one or more transform parameters of each transformation were provided to the XGBoost model as the target variable for training the XGBoost model. For each transformation, the input variables comprised a corresponding time series of the condition parameters set out above at each of a plurality of time points for 15 minutes up to and including the time of obtaining the spectrum corresponding to the transformation. The XGBoost model was fit to the training data using the input and output variables by training the model to minimize the mean squared error.

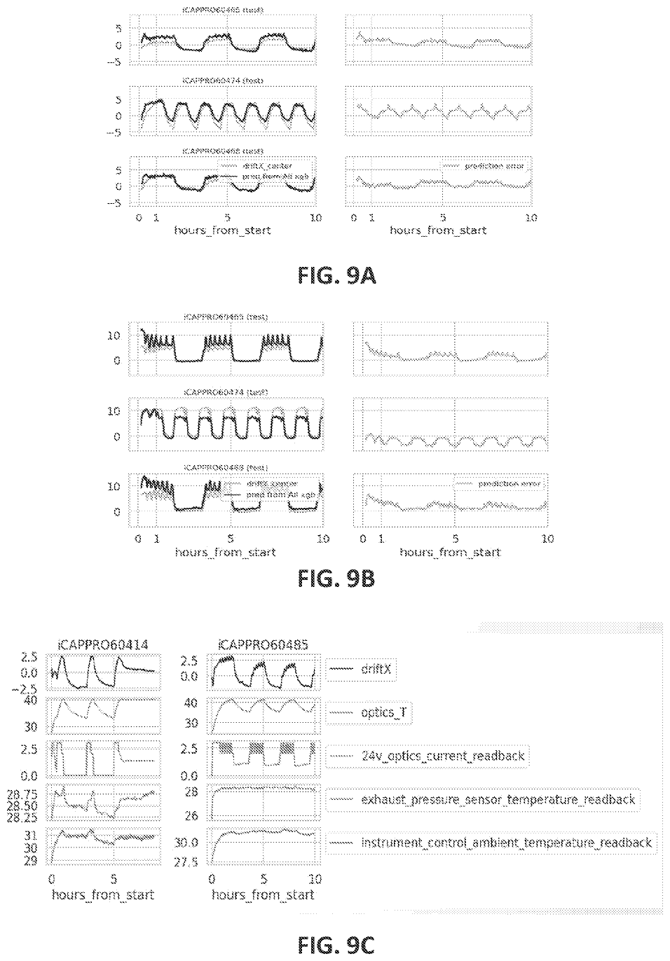

Hyperparameters of the XGBoost model were tuned to maximise model performance on the validation dataset. During hyperparameter tuning, the model was selected based on performance on the validation dataset, specifically the model with the lowest mean absolute error in the predictions between 0.5 to 10 hours after instrument start time was chosen. A detailed description of XGBoost model hyperparameters is described in the algorithm documentation (https://xgboost.readthedocs.io/en/stable/parameter.html). FIGS. 9A and 9B show the performance of the trained model on the test data on 3 of the optical emission spectrometers (iCAPPRO60465 (test), iCAPPRO60474 (test) and iCAPPRO60468 (test)). FIG. 9A shows a prediction of lateral drift by the XGBoost model on the 3 instruments from which the test data set was obtained. Left: actual drift (grey) and predicted drift (black) Right: prediction error (difference). FIG. 9B shows a prediction of vertical drift by the XGBoost model on the 3 instruments from which the test data set was obtained. Left: actual drift (grey) and predicted drift (black) Right: prediction error (difference). The low frequency waves which show the biggest changes in drift are as a result of temperature cycling of the heating pads which is consistent with the understanding that drift is caused due to thermal deformation of components of the optical system. The high frequency waves which show the smaller changes in drift are as a result of the rapid (for example every 1-2 minutes) changes in RF supplied to the plasma.

### Exploratory Testing on the Dataset

The individual condition parameters used to train the model, allow the model to predict the drift to a different extent. To explore this, spectra were obtained at a sampling frequency of 1 spectrum/min and the condition parameters indicative of operating conditions were collected at a sampling frequency of 1 every 6 seconds and individual machine learning models were trained using each of the condition parameters in isolation. The mean squared error of each trained model was calculated using:

$$MSE = \frac{1}{n} {\sum }_{i = 1}^{n} {( True {drift}_{i} - Predicted {drift}_{i} )}^{2} ,$$

where n is the number of spectra (number of data points). For each condition parameter. One or more models were trained, each of which, trained using data collected over a different amount of time prior to obtaining the spectrum. Table 1 shows results of this exploratory testing. As indicated above, the mean squared error indicates the deviation in the predicted drift predicted from the true drift. In the exploratory testing captured in table 1, the drift in the x direction (lateral drift) was used to obtain the mean squared error. The rolling history window indicates the amount of time prior to obtaining the spectra for each variable that gave the model with the lowest mean squared error. The best fit using the individual parameters was obtained for the temperature of the optical system, the change in temperature of the optical system, the current at the optical system circuit board and the voltage across the heating pad. This is consistent with the understanding that drift may be caused due to thermal deformation of components of the optical system. Another driver for temperature changes in the optical system is the heat emitted by the plasma located proximal to the optical system. The temperature at the RF power supply, which is proximal and hence correlated with the plasma temperature provides an intermediate fit as an individual parameter. Other parameters have been found to be less good individual predictors of the spectrum distortion.

TABLE 1
Results of an exploratory test showing the mean squared
error of a model predicting spectral drift trained
using each condition parameter in isolation

| | Rolling | |
|---|---|---|
| | history | |
| | window in | |
| MSE | minutes | Parameter |
| 0.015 | 15 | Current at the optical system circuit board |
| 0.016 | 15 | Temperature of the optical system |
| 0.017 | 15 | Change in temperature of the optical system |
| 0.018 | 15 | Voltage at the optical system heating pad |
| 0.022 | 15 | Temperature of the power supply of the RF generator |
| 0.035 | 1 | Voltage at the power supply of the RF generator |
| 0.035 | 15 | Current at the camera's printed circuit board (PCB) |
| 0.035 | 15 | Temperature around the scientific instrument |
| 0.036 | 1 | Temperature of the exhaust tube used to aspirate |
| | | exhaust plasma gases |
| 0.036 | 5 | Current at the control board of the spectrometer |
| 0.037 | 5 | Temperature of a printed circuit board controlling |
| | | optical system heating pad |
| 0.037 | 5 | Current at the power supply of the RF generator |
| 0.037 | 1 | Pressure in the exhaust tube used to aspirate |
| | | exhaust plasma gases |

FIG. 9C shows a comparison between the actual lateral drift (first row) and the predicted lateral drift (subsequent rows) resulting from the exploratory testing by training a machine learning models using just one condition parameter and then predicting drift in two different spectrometers (iCAPPRO60614 and iCAPPRO60485). FIG. 9C shows the drift predicted by models trained using just temperature or just the current at the optical system circuit board are closer to the true drift than either the exhaust pressure (pressure in the exhaust tube used to aspirate exhaust plasma gases) or ambient temperature (temperature around the scientific instrument). When compared with FIG. 9A and FIG. 9B, FIG. 9C also suggests that the current at the optical system circuit board is good at predicting the drift caused by the fluctuations in RF supplied to the plasma. This is consistent with the proximity of the plasma to the optical system which results in a correlation between the current supplied to the heating pads to keep the optical system at a stable temperature and the RF supplied to the plasma.

### Computing Infrastructure

As noted above, the scientific instrument support module 2000 may be implemented by one or more computing devices. FIG. 11 is a block diagram of a computing device 11000 that may perform some or all of the scientific instrument support methods disclosed herein, in accordance with various embodiments. In some embodiments, the scientific instrument support module 2000 may be implemented by a single computing device 11000 or by multiple computing devices 11000. Further, as discussed below, a computing device 1100 (or multiple computing devices 11000) that implements the scientific instrument support module 1000 may be part of one or more of the scientific instrument 12010, the user local computing device 12020, the service local computing device 12010, or the remote computing device 12040 of FIG. 12.

The computing device 11000 of FIG. 11 is illustrated as having a number of components, but any one or more of these components may be omitted or duplicated, as suitable for the application and setting. In some embodiments, some or all of the components included in the computing device 11000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 11002 and one or more storage devices 11004). In some embodiments, one or more of these components may be remote to the computing device 11000. Additionally, in various embodiments, the computing device 11000 may not include one or more of the components illustrated in FIG. 11, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 11000 may not include a display device 11010, but may include display device interface circuitry (e.g., a connector and driver circuitry) to which a display device 11010 may be coupled.

The computing device 11000 may include a processing device 11002 (e.g., one or more processing devices). As used herein, the term “processing device” may refer to any device or portion of a device that processes electronic data from registers and/or memory to transform that electronic data into other electronic data that may be stored in registers and/or memory. The processing device 11002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 11000 may include a storage device 11004 (e.g., one or more storage devices). The storage device 11004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 11004 may include memory that shares a die with a processing device 11002. In such an embodiment, the memory may be used as cache memory and may include embedded dynamic random access memory (eDRAM) or spin transfer torque magnetic random access memory (STT-MRAM), for example. In some embodiments, the storage device 11004 may include non-transitory computer readable media having instructions thereon that, when executed by one or more processing devices (e.g., the processing device 11002), cause the computing device 11000 to perform any appropriate ones of or portions of the methods disclosed herein.

The computing device 11000 may include an interface device 11006 (e.g., one or more interface devices 11006). The interface device 11006 may include one or more communication chips, connectors, and/or other hardware and software to govern communications between the computing device 11000 and other computing devices. For example, the interface device 11006 may include circuitry for managing wireless communications for the transfer of data to and from the computing device 11000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 11006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 11006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 11006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 11006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 11006 may include one or more antennas (e.g., one or more antenna arrays) to receipt and/or transmission of wireless communications.

In some embodiments, the interface device 11006 may include circuitry for managing wired communications, such as electrical, optical, or any other suitable communication protocols. For example, the interface device 11006 may include circuitry to support communications in accordance with Ethernet technologies. In some embodiments, the interface device 11006 may support both wireless and wired communication, and/or may support multiple wired communication protocols and/or multiple wireless communication protocols. For example, a first set of circuitry of the interface device 11006 may be dedicated to shorter-range wireless communications such as Wi-Fi or Bluetooth, and a second set of circuitry of the interface device 11006 may be dedicated to longer-range wireless communications such as global positioning system (GPS), EDGE, GPRS, CDMA, WIMAX, LTE, EV-DO, or others. In some embodiments, a first set of circuitry of the interface device 11006 may be dedicated to wireless communications, and a second set of circuitry of the interface device 11006 may be dedicated to wired communications.

The computing device 11000 may include battery/power circuitry 11008. The battery/power circuitry 11008 may include one or more energy storage devices (e.g., batteries or capacitors) and/or circuitry for coupling components of the computing device 11000 to an energy source separate from the computing device 11000 (e.g., AC line power).

The computing device 11000 may include a display device 11010 (e.g., multiple display devices). The display device 11010 may include any visual indicators, such as a heads-up display, a computer monitor, a projector, a touchscreen display, a liquid crystal display (LCD), a light-emitting diode display, or a flat panel display.

The computing device 11000 may include other input/output (I/O) devices 11012. The other I/O devices 11012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 11000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 11000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 12 is a block diagram of an example scientific instrument support system 12000 in which some or all of the scientific instrument support methods disclosed herein may be performed, in accordance with various embodiments. The scientific instrument support modules and methods disclosed herein (e.g., the scientific instrument support module 1000 of FIG. 2 and the methods 5000, 6000, 7000 of FIG. 5, 6, 7) may be implemented by one or more of the scientific instruments 12010, the user local computing device 12020, the service local computing device 12030, or the remote computing device 12040 of the scientific instrument support system 12000.

Any of the scientific instrument 12010, the user local computing device 12020, the service local computing device 12030, or the remote computing device 12040 may include any of the embodiments of the computing device 11000 discussed herein with reference to FIG. 11, and any of the scientific instrument 12010, the user local computing device 12020, the service local computing device 12030, or the remote computing device 12040 may take the form of any appropriate ones of the embodiments of the computing device 11000 discussed herein with reference to FIG. 11.

The scientific instrument 12010, the user local computing device 12020, the service local computing device 12030, or the remote computing device 12040 may each include a processing device 12002, a storage device 12004, and an interface device 12006. The processing device 12002 may take any suitable form, including the form of any of the processing devices 11002 discussed herein with reference to FIG. 11, and the processing devices 12002 included in different ones of the scientific instrument 12010, the user local computing device 12020, the service local computing device 12030, or the remote computing device 12040 may take the same form or different forms. The storage device 12004 may take any suitable form, including the form of any of the storage devices 11004 discussed herein with reference to FIG. 11, and the storage devices 12004 included in different ones of the scientific instrument 12010, the user local computing device 12020, the service local computing device 12030, or the remote computing device 12040 may take the same form or different forms. The interface device 12006 may take any suitable form, including the form of any of the interface devices 11006 discussed herein with reference to FIG. 11, and the interface devices 12006 included in different ones of the scientific instrument 12010, the user local computing device 12020, the service local computing device 12030, or the remote computing device 12040 may take the same form or different forms.

The scientific instrument 12010, the user local computing device 12020, the service local computing device 12030, and the remote computing device 12040 may be in communication with other elements of the scientific instrument support system 12000 via communication pathways 12008. The communication pathways 12008 may communicatively couple the interface devices 12006 of different ones of the elements of the scientific instrument support system 12000, as shown, and may be wired or wireless communication pathways (e.g., in accordance with any of the communication techniques discussed herein with reference to the interface devices 11006 of the computing device 11000 of FIG. 11). The particular scientific instrument support system 12000 depicted in FIG. 12 includes communication pathways between each pair of the scientific instrument 12010, the user local computing device 12020, the service local computing device 12030, and the remote computing device 12040, but this “fully connected” implementation is simply illustrative, and in various embodiments, various ones of the communication pathways 12008 may be absent. For example, in some embodiments, a service local computing device 12030 may not have a direct communication pathway 12008 between its interface device 12006 and the interface device 12006 of the scientific instrument 12010, but may instead communicate with the scientific instrument 12010 via the communication pathway 12008 between the service local computing device 12030 and the user local computing device 12020 and the communication pathway 12008 between the user local computing device 12020 and the scientific instrument 12010.

The scientific instrument 12010 may include any appropriate scientific instrument, such as an optical emission spectrometer, for example the inductive coupled plasma optical emission spectrometer 1000 as shown in FIG. 1.

The user local computing device 12020 may be a computing device (e.g., in accordance with any of the embodiments of the computing device 11000 discussed herein) that is local to a user of the scientific instrument 12010. In some embodiments, the user local computing device 12020 may also be local to the scientific instrument 12010, but this need not be the case; for example, a user local computing device 12020 that is in a user's home or office may be remote from, but in communication with, the scientific instrument 12010 so that the user may use the user local computing device 12020 to control and/or access data from the scientific instrument 12010. In some embodiments, the user local computing device 12020 may be a laptop, smartphone, or tablet device. In some embodiments the user local computing device 12020 may be a portable computing device.

The service local computing device 12030 may be a computing device (e.g., in accordance with any of the embodiments of the computing device 11000 discussed herein) that is local to an entity that services the scientific instrument 12010. For example, the service local computing device 12030 may be local to a manufacturer of the scientific instrument 12010 or to a third-party service company. In some embodiments, the service local computing device 12030 may communicate with the scientific instrument 12010, the user local computing device 12020, and/or the remote computing device 12040 (e.g., via a direct communication pathway 12008 or via multiple “indirect” communication pathways 12008, as discussed above) to receive data regarding the operation of the scientific instrument 12010, the user local computing device 12020, and/or the remote computing device 12040 (e.g., the results of self-tests of the scientific instrument 12010, calibration coefficients used by the scientific instrument 12010, the measurements of sensors associated with the scientific instrument 12010, etc.). In some embodiments, the service local computing device 12030 may communicate with the scientific instrument 12010, the user local computing device 12020, and/or the remote computing device 12040 (e.g., via a direct communication pathway 12008 or via multiple “indirect” communication pathways 12008, as discussed above) to transmit data to the scientific instrument 12010, the user local computing device 12020, and/or the remote computing device 12040 (e.g., to update programmed instructions, such as firmware, in the scientific instrument 12010, to initiate the performance of test or calibration sequences in the scientific instrument 12010, to update programmed instructions, such as software, in the user local computing device 12020 or the remote computing device 12040, etc.). A user of the scientific instrument 12010 may utilize the scientific instrument 12010 or the user local computing device 12020 to communicate with the service local computing device 12030 to report a problem with the scientific instrument 12010 or the user local computing device 12020, to request a visit from a technician to improve the operation of the scientific instrument 12010, to order consumables or replacement parts associated with the scientific instrument 12010, or for other purposes.

The remote computing device 12040 may be a computing device (e.g., in accordance with any of the embodiments of the computing device 11000 discussed herein) that is remote from the scientific instrument 12010 and/or from the user local computing device 12020. In some embodiments, the remote computing device 12040 may be included in a datacenter or other large-scale server environment. In some embodiments, the remote computing device 12040 may include network-attached storage (e.g., as part of the storage device 12004). The remote computing device 12040 may store data generated by the scientific instrument 12010, perform analyses of the data generated by the scientific instrument 12010 (e.g., in accordance with programmed instructions), facilitate communication between the user local computing device 12020 and the scientific instrument 12010, and/or facilitate communication between the service local computing device 12030 and the scientific instrument 12010.

In some embodiments, one or more of the elements of the scientific instrument support system 12000 illustrated in FIG. 12 may not be present. Further, in some embodiments, multiple ones of various ones of the elements of the scientific instrument support system 12000 of FIG. 12 may be present. For example, a scientific instrument support system 12000 may include multiple user local computing devices 12020 (e.g., different user local computing devices 12020 associated with different users or in different locations). In another example, a scientific instrument support system 12000 may include multiple scientific instruments 12010, all in communication with service local computing device 12030 and/or a remote computing device 12040; in such an embodiment, the service local computing device 12030 may monitor these multiple scientific instruments 12010, and the service local computing device 12030 may cause updates or other information may be “broadcast” to multiple scientific instruments 12010 at the same time. Different ones of the scientific instruments 12010 in a scientific instrument support system 12000 may be located close to one another (e.g., in the same room) or farther from one another (e.g., on different floors of a building, in different buildings, in different cities, etc.). In some embodiments, a scientific instrument 12010 may be connected to an Internet-of-Things (IoT) stack that allows for command and control of the scientific instrument 12010 through a web-based application, a virtual or augmented reality application, a mobile application, and/or a desktop application. Any of these applications may be accessed by a user operating the user local computing device 12020 in communication with the scientific instrument 12010 by the intervening remote computing device 12040. In some embodiments, a scientific instrument 12010 may be sold by the manufacturer along with one or more associated user local computing devices 12020 as part of a local scientific instrument computing unit 12012.

In some embodiments, different ones of the scientific instruments 12010 included in a scientific instrument support system 12000 may be different types of scientific instruments 12010; for example, one scientific instrument 12010 may be an optical emission spectrometer. In some such embodiments, the remote computing device 12040 and/or the user local computing device 12020 may combine data from different types of scientific instruments 12010 included in a scientific instrument support system 12000.

1. A method of mitigating distortion of an optical emission spectrum obtained from an optical emission spectrometer, wherein the optical emission spectrometer comprises an optical system for forming the optical emission spectrum, the method comprising:
obtaining a spectrum recorded with the optical emission spectrometer and input data comprising one or more condition parameters indicative of an operating condition of the optical emission spectrometer or an environment of the optical emission spectrometer at a time of recording the spectrum with the optical emission spectrometer;
providing a machine learning model configured to output, in response to the input data, output data comprising one or more transform parameters of a transformation to be applied to the obtained spectrum to mitigate distortion of the spectrum due to a discrepancy between the operating condition and a baseline operating condition;
applying the input data as an input to the machine learning model and obtaining one or more transform parameters as an output of the machine learning model; and
applying the transformation in accordance with the obtained one or more transform parameters to the obtained spectrum to mitigate distortion of the spectrum due to a discrepancy between the operating condition and the baseline operating condition.

2. The method of claim 1, wherein the spectrum comprises sets of intensity values over respective two-dimensional locations, and wherein the transformation comprises an operation that varies across locations.

3. The method of claim 2, wherein the operation comprises applying a deformation field to the optical emission spectrum.

4. The method of claim 1, wherein the one or more condition parameters comprise a parameter indicative of a temperature.

5. The method of claim 1, wherein the one or more condition parameters are indicative of an operating condition of the optical system of the optical emission spectrometer.

6. The method of claim 4, wherein the one or more condition parameters comprise at least one temperature measurement obtained from a temperature sensor attached to a mechanical structure of the optical emission spectrometer.

7. The method of claim 6, wherein the mechanical structure of the optical emission spectrometer supports one or more optical components of the optical system.

8. The method of claim 1, wherein the one or more condition parameters comprises one or more condition change parameters indicative of a change of the operating condition or a direction of change of the operating condition.

9. The method of claim 1, wherein the input data comprises a time series of the one or more condition parameters at each of a plurality of time points.

10. The method of claim 9, wherein the output data comprises a corresponding time series of one or more transform parameters of a transformation at each of the plurality of time points, and wherein the method comprises applying the transformation in accordance with the one or more transform parameters corresponding to a time point of the time series of the output data to the optical emission spectrum obtained at the time point.

11. The method of claim 1, wherein the machine learning model comprises a decision-tree based ensemble machine learning algorithm.

12. The method of claim 1, wherein the transformation comprises one or more of: a translation; a rotation; a scaling operation; a skewing operation, a stretching operation; or a deformation field.

13. The method of claim 1, wherein the one or more condition parameters comprise one or more of:
a parameter indicative of a heating current applied to a heating arrangement for heating and stabilizing a temperature of the optical system;
a parameter indicative of a temperature of an environment of the optical emission spectrometer;
a parameter indicative of the temperature of the optical system;
a parameter indicative of at least one temperature measurement obtained from a temperature sensor attached to a mechanical structure supporting one or more optical components of the optical system;
a parameter indicative of an RF power of an RF generator for generating a plasma for use in obtaining the spectrum; or
a parameter indicative of an exhaust pressure of a plasma chamber for containing a plasma for use in obtaining the spectrum.

14. The method of claim 1, wherein the optical emission spectrometer is a plasma emission spectrometer configured to record an emission spectrum of light emitted from a plasma.

15. The method of claim 1, wherein the spectrum is an echelle spectrum.

16. One or more non-transitory computer readable media comprising instructions thereon that, when executed by one or more processing devices of a scientific instrument support apparatus, cause the scientific instrument support apparatus to:
obtain a spectrum recorded with an optical emission spectrometer and input data comprising one or more condition parameters indicative of an operating condition of the optical emission spectrometer or an environment of the optical emission spectrometer at a time of recording the spectrum with the optical emission spectrometer;
apply the input data as an input to a machine learning model that is configured to output, in response to the input data, output data comprising one or more transform parameters of a transformation to be applied to the obtained spectrum to mitigate distortion of the spectrum due to a discrepancy between the operating condition and a baseline operating condition;
obtain one or more transform parameters as an output of the machine learning model; and
apply the transformation in accordance with the obtained one or more transform parameters to the obtained spectrum to mitigate distortion of the spectrum due to a discrepancy between the operating condition and the baseline operating condition.

17-19. (canceled)

20. A method of obtaining training data for training a machine learning model, the method comprising:
recording a plurality of optical emission spectra of a reference analyte with an optical emission spectrometer for respective operating conditions of the optical emission spectrometer;
storing input data for the machine learning model, the input data comprising, for each recorded optical emission spectrum, one or more parameters indicative of the respective operating condition;
for each recorded optical emission spectrum, adjusting one or more transform parameters of a transform to register the optical emission spectrum to a baseline optical emission spectrum of the reference analyte using the transform, wherein the baseline optical emission spectrum was recorded for a baseline operating condition; and
storing output data for the machine learning model comprising, for each optical emission spectrum, the respective adjusted one or more transform parameters in association with the respective input data for each optical emission spectrum as a training data pair.

21. The method of claim 20, wherein the optical emission spectrum and the baseline optical emission spectrum each comprise sets of intensity values over respective two-dimensional locations, and wherein the transform comprises an operation that varies across multiple locations.

22. The method of claim 21, wherein the operation comprises applying a distortion field to the optical emission spectrum.

23. The method of claim 21, wherein the optical emission spectrum and the baseline optical emission spectrum are respective images and adjusting the one or more transform parameters comprises comparing respective image intensities between the respective images.

24-26. (canceled)
